(19) United States
(12) Patent Application Publication
(10) Pub. No.: US 2024/0291924 A1
(43) Pub. Date: Aug. 29, 2024

(54) INFORMATION DISPLAY DEVICE AND COMPUTER PROGRAM

(71) Applicant: FUJIFILM CORPORATION, Minato-ku, Tokyo (JP)

(72) Inventors: Tatsuo FUKUSHIMA, Kanagawa (JP); Yuji ONOZAWA, Kanagawa (JP); Takafumi HARUTA, Kanagawa (JP); Yohei MAKINO, Kanagawa (JP)

(21) Appl. No.: 18/570,035

(22) PCT Filed: Jul. 21, 2022
(86) PCT No.: PCT/JP2022/028377

§ 371 Date: Dec. 13, 2023

(30) Foreign Application Priority Data
Jul. 29, 2021 (JP) 2021-124731

(51) Int. Cl. H04N 1/00

(52) U.S. Cl. CPC H04N 1/00506; H04N 1/00408; H04N 1/00477

(57) ABSTRACT

An information display device 10 includes a CPU 11. The CPU 11 executes processing including collecting device information, acquiring priority information to prioritize for display based on the collected information, and displaying the acquired priority information at a specific region at an operation screen displayed at a user interface.

### TECHNICAL FIELD

The present invention relates to an information display device and a computer program.

### BACKGROUND ART

Patent Document 1 discloses a user interface control device that controls an operation screen displayed at a user interface based on a setting of the operation screen, and that also receives input to change the setting of the operation screen and displays, at the user interface, information related to mis-operation of the operation screen when a setting change has been performed based on the input.

### TECHNICAL LITERATURE

### Patent Literature

Patent Document 1: Japanese Patent Application Laid-Open (JP-A) No. 2009-237820

### SUMMARY OF INVENTION

### Technical Problem

In order to effectively utilize an operation screen displayed at a user interface, in cases in which information related to an operation target device is displayed in a region for receiving execution of processing, sometimes the intention of information is not able to be correctly conveyed to a user depending on the content of the information displayed.

An object of the present invention is to provide an information display device and a computer program that are able to convey information that should be prioritized and verified to a user when displaying information related to an operation target device in a region that receives an operation instruction.

### Solution to Problem

An information display device according to a first aspect of the present invention includes a processor. The processor executes processing including collecting device information, acquiring priority information to prioritize for display based on the collected information, and displaying the acquired priority information at a specific region at an operation screen displayed at a user interface.

An information display device according to a second aspect of the present invention is the information display device according to the first aspect wherein the processor displays, as the priority information, information related to an event that occurs due to processing executed based on an operation instruction from a user.

An information display device according to a third aspect of the present invention is the information display device according to the second aspect wherein the processor acquires the priority information in accordance with a change of setting for the processing.

An information display device according to a fourth aspect of the present invention is the information display device according to the first aspect wherein the processor displays information related to an event occurring at the device as the priority information.

An information display device according to a fifth aspect of the present invention is the information display device according to the fourth aspect wherein the processor acquires the priority information in accordance with a change in setting on the device.

An information display device according to a sixth aspect of the present invention is the information display device according to any one of the first aspect to the fifth aspect, wherein the processor acquires the priority information in accordance with a change of content being displayed at the operation screen.

An information display device according to a seventh aspect of the present invention is the information display device according to the sixth aspect, wherein the processor acquires the priority information in accordance with a screen transition operation from a user on the user interface.

An information display device according to an eighth aspect of the present invention is the information display device according to the seventh aspect, wherein the processor acquires the priority information in accordance with a scroll operation from the user on the user interface.

An information display device according to a ninth aspect of the present invention is the information display device according to any one of the first aspect to the eighth aspect, wherein the specific region is a region for receiving execution of processing from a user.

An information display device according to a tenth aspect of the present invention is the information display device according to any one of the first aspect to the eighth aspect, wherein the specific region is a region displayed overlaid on the operation screen.

An information display device according to an eleventh aspect of the present invention is the information display device according to any one of the first aspect to the tenth aspect, wherein the processor acquires the priority information by cross-checking content of the collected information against a pre-established table.

An information display device according to a twelfth aspect of the present invention is the information display device according to the eleventh aspect, wherein the processor acquires the priority information by taking into account a result of cross-checking information related to content being displayed at the operation screen.

A computer program according to a thirteenth aspect of present invention causes a computer to execute processing. The processing includes collecting device information, acquiring priority information to prioritize for display based on the collected information, and displaying the acquired priority information at a specific region at an operation screen displayed at a user interface.

### Advantageous Effects of Invention

The first aspect of the present invention enables correct conveying of information that should be prioritized and verified to a user.

The second aspect of the present invention enables a user to be made aware of an event that might occur as a result of processing executed by the user prior to execution of the processing as the information that should be prioritized and displayed to a user.

The third aspect of the present invention enables a user to be made aware of an event that might occur by a user executing processing as a result processing executed by the user resulting from a setting for the processing being changed as the information that should be prioritized and displayed to a user.

The fourth aspect of the present invention enables a user to be made aware of an event currently occurring in the device as the information that should be prioritized and displayed to a user.

The fifth aspect of the present invention enables a user to be made aware of an event currently occurring in the device as a result of a setting changed for the processing as the information that should be prioritized and displayed to a user.

The sixth aspect of the present invention enables a user to be made aware of information that should be prioritized and displayed to a user in accordance with a change in content being displayed on the operation screen.

The seventh aspect of the present invention enables a user to be made aware of information that should be prioritized and displayed to a user in accordance with a screen transition operation on the user interface.

The eighth aspect of the present invention enables a user to be made aware of information that should be prioritized and displayed to a user in accordance with a scroll operation on the user interface.

The ninth aspect of the present invention enables a region for receiving execution of processing from a user to be effectively utilized as a display region of information that should be prioritized and displayed to a user.

The tenth aspect of the present invention enables a region displayed overlaid on the operation screen to be effectively utilized as the display region for information that should be prioritized and displayed to a user.

The eleventh aspect of the present invention enables a user to be made aware of the information that should be prioritized and displayed to a user by a result of cross-checking against pre-established information that should be prioritized and displayed.

The twelfth aspect of the present invention enables a user to be made aware of information that should be prioritized and displayed to a user taking into consideration a result of cross-checking information related to content being displayed at the operation screen.

The thirteenth aspect of the present invention enables correct conveying of information that should be prioritized and verified to a user.

### BRIEF DESCRIPTION OF DRAWINGS

FIG. 1 is a block diagram illustrating the hardware configuration of an information display device according to an exemplary embodiment of technology disclosed herein.

FIG. 2 is a block diagram illustrating an example of a functional configuration of an information display device.

FIG. 3 is a flowchart illustrating a flow of information display processing by an information display device.

FIG. 4 is a diagram illustrating an example of a user interface.

FIG. 5 is a diagram illustrating an example of a user interface.

FIG. 6 is a diagram illustrating an example of a user interface.

FIG. 7 is a diagram illustrating an example of a table referenced when deciding priority information.

FIG. 8 is a diagram to explain adding points to or weighting defined priorities.

FIG. 9 is a diagram to explain adding points to or weighting defined priorities.

FIG. 10 is a diagram illustrating an example of display of a user interface.

FIG. 11 is a diagram illustrating an example of display of a user interface.

FIG. 12 is a diagram illustrating an example of display of a user interface.

FIG. 13 is a diagram illustrating an example of display of a user interface.

FIG. 14 is a diagram illustrating an example of display of a user interface.

### DESCRIPTION OF EMBODIMENTS

Description follows regarding an example of an exemplary embodiment of the present invention, with reference to the drawings. Note that the same reference numerals are appended in the drawings to configuration elements and parts that are the same or equivalent. Moreover, dimensional proportions in the drawings are exaggerated for ease of explanation and sometimes differ from actual proportions.

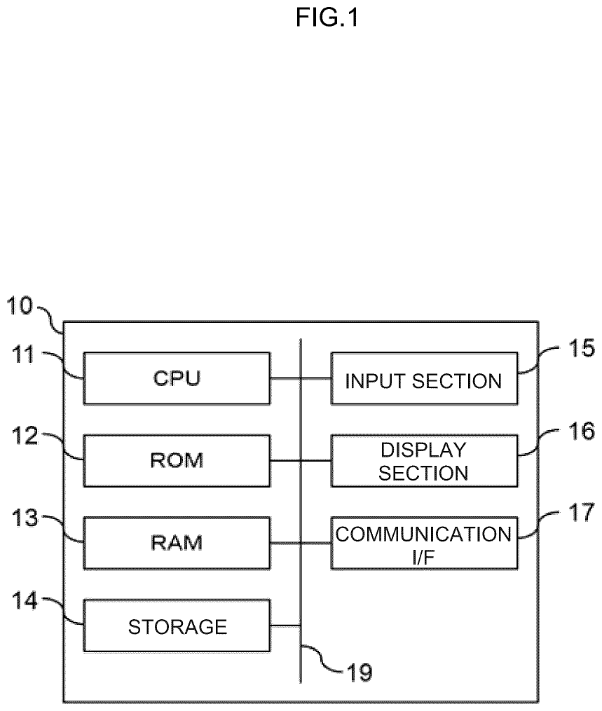

FIG. 1 is a block diagram illustrating a hardware configuration of an information display device 10 according to the present exemplary embodiment. The information display device 10 is provided with a printing function and a facsimile function, and may be an image forming device for displaying a graphical user interface (GUI), an information processing device such as a smartphone, or the like.

As illustrated in FIG. 1, the information display device 10 includes a central processing unit (CPU) 11, read only memory (ROM) 12, random access memory (RAM) 13, storage 14, an input section 15, a display section 16, and a communication interface (I/F) 17. Each configuration is connected so as to be capable of communicating with each other through a bus 19.

The CPU 11 is a central processing unit for executing various programs, and controlling each section. Namely, the CPU 11 reads a program from the ROM 12 or the storage 14, and executes the program using the RAM 13 as workspace. The CPU 11 controls each of the above configuration and performs various computation processing according to the program stored on the ROM 12 or the storage 14. In the present exemplary embodiment, an information display program for displaying a graphical user interface is stored on the ROM 12 or the storage 14.

The ROM 12 stores various programs and various data. The RAM 13 serves as a workspace to temporarily store a program or data. The storage 14 is configured by a storage device such as a hard disk drive (HDD), solid state drive (SSD), flash memory, or the like, and stores various programs including an operating system, and various data.

The input section 15 includes a pointing device such as a mouse, and a keyboard, and is employed to perform various inputs.

The display section 16 is, for example, a liquid crystal display, and displays various information. In the present exemplary embodiment, a touch panel style is adopted for the display section 16, which also functions as the input section 15.

The communication interface 17 is an interface for communicating with other devices and employs, for example, a standard such as Ethernet (registered trademark), FDDI, or Wi-Fi (registered trademark).

When the above information display program is executed, the information display device 10 employs the hardware resources described above to implement various functions. Description follows regarding a functional configuration implemented by the information display device 10.

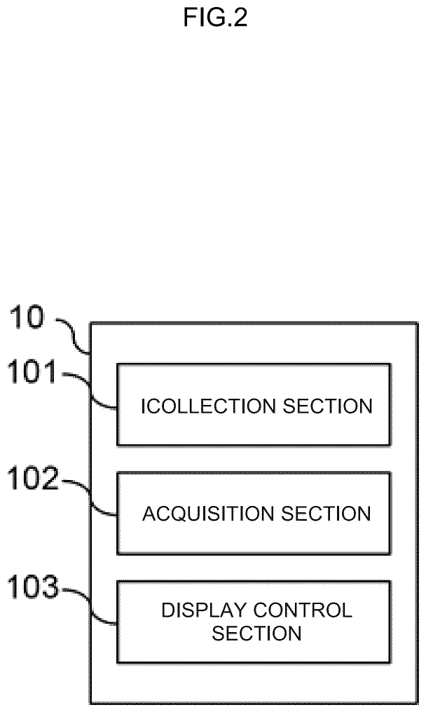

FIG. 2 is a block diagram illustrating an example of a functional configuration of the information display device 10.

As illustrated in FIG. 2, the information display device 10 includes, as functional configuration, a collection section 101, an acquisition section 102, and a display control section 103. Each of the functional configuration is implemented by the CPU 11 reading and executing the information display program stored on the ROM 12 or the storage 14.

The collection section 101 collects information of the information display device 10. The information to be collected may differ depending on the device type of the information display device 10. For example, in cases in which the information display device 10 is an image forming device, the collection section 101 acquires, for example, an information display state of the display section 16, a state of print settings, transmission settings, disposable components, log information such as a transmission record, a setting record, or the like, and environment information such as temperature, time, or the like. The environment information may be acquired by a sensor provided to the information display device 10. The print settings may, for example, be a number of print copies, size of paper, printing side (single-sided or double-sided), number of pages per single sheet, color settings (color or black and white), or the like. The transmission settings may be a facsimile transmission destination, a paper size, a transmission quality, or the like.

The acquisition section 102 acquires priority information to prioritize for display based on the information collected by the collection section 101. The priority information is, for example, information related to an event occurring due to processing being executed based on an operation instruction from a user to the information display device 10. The priority information is, moreover for example, information related to an event currently occurring in the information display device 10.

Consider examples of information related to an event occurring due to processing being executed based on an operation instruction from a user to the information display device 10. In cases in which the information display device 10 is an image forming device, when it is thought that toner is insufficient to execute a set print job, the acquisition section 102 acquires a message urging a change of setting such as a reduction in the number of copies as the priority information. Moreover, in cases in which the information display device 10 is an image forming device, when it is thought that paper is insufficient to execute a set print job, the acquisition section 102 acquires as the priority information a message urging a change of setting, such as a reduction in the number of copies, replenishment of paper, or the like.

Explanation follows regarding an example of information related to an event currently occurring in the information display device 10. In cases in which the information display device 10 is an image forming device, irrespective of the set content, when the remaining toner is already less than a specific value, the acquisition section 102 acquires as the priority information a message urging readying of a spare toner or replacement with a spare toner.

More specifically, the acquisition section 102 cross-checks the information collected by the collection section 101 against information stored in the storage 14 or the like. The acquisition section 102 acquires the priority information for prioritizing display by cross-checking against this information.

The display control section 103 controls display of the user interface on the display section 16. More specifically, the display control section 103 displays the acquired priority information at a specific region at the operation screen displayed at the user interface. Specific examples of the priority information displayed on the display section 16 are described later.

The information display device 10 according to the present exemplary embodiment includes the above configuration, and so is able to display information with the highest priority based on the information related to the information display device 10. The information display device 10 according to the present exemplary embodiment is able to clearly convey information that should be prioritized and verified to the user by displaying the information with the highest priority based on the information related to the information display device 10.

Next explanation follows regarding operation of the information display device 10.

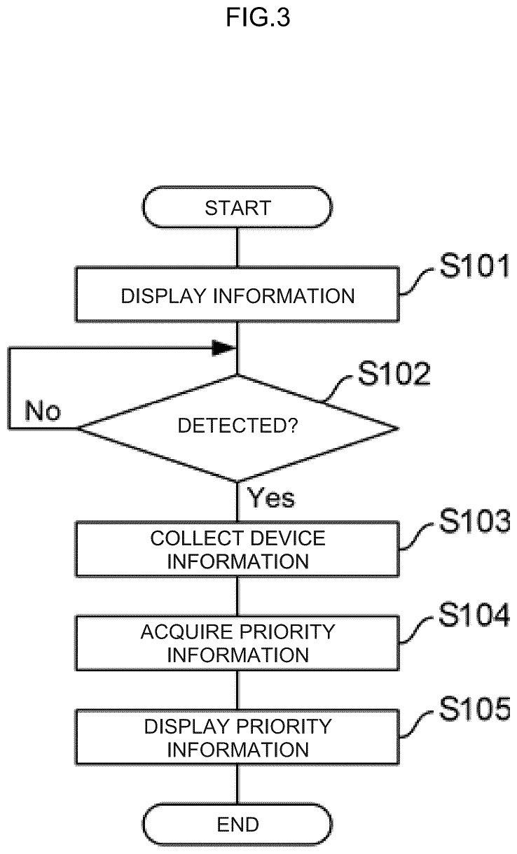

FIG. 3 is a flowchart illustrating a flow of the information display processing by the information display device 10. The information display processing is performed by the CPU 11 reading the information display program from the ROM 12 or the storage 14, and expanding and executing the information display program in the RAM 13.

The CPU 11 determines whether or not an operation from a user to the display section 16 has been detected (step S102) in a state in which information is being displayed on the display section 16 (step S101). The CPU 11 determines detection of an operation from the user to the display section 16 by whether or not a finger of the user has touched or is in close proximity to the display section 16.

When the result of determination at step S102 is that an operation from the user to the display section 16 has not been detected (step S102: No), the CPU 11 repeats the determination of step S102 until an operation from the user to the display section 16 is detected. When the result of determination at step S102 is that an operation from the user to the display section 16 has been detected (step S102: Yes), the CPU 11 continues and collects information of the information display device 10 (step S103). In cases in which the information display device 10 is an image forming device, the CPU 11, for example as described above, acquires the information display state of the display section 16, the state of print settings, transmission settings, disposable components, the log information such as a transmission record, a setting record, or the like, and environment information such as temperature, time, or the like.

Continuing from step S103, the CPU 11 acquires the priority information for prioritizing display (step S104) based on the information collected at step S103. The priority information includes, for example, information related to an event occurring due to processing being executed based on an operation instruction from a user to the information display device 10. The priority information also includes, for example, information related to an event currently occurring in the information display device 10.

Continuing from step S104, the CPU 11 displays the acquired priority information at a specific region of the operation screen being displayed at the user interface for display on the display section 16 (step S105).

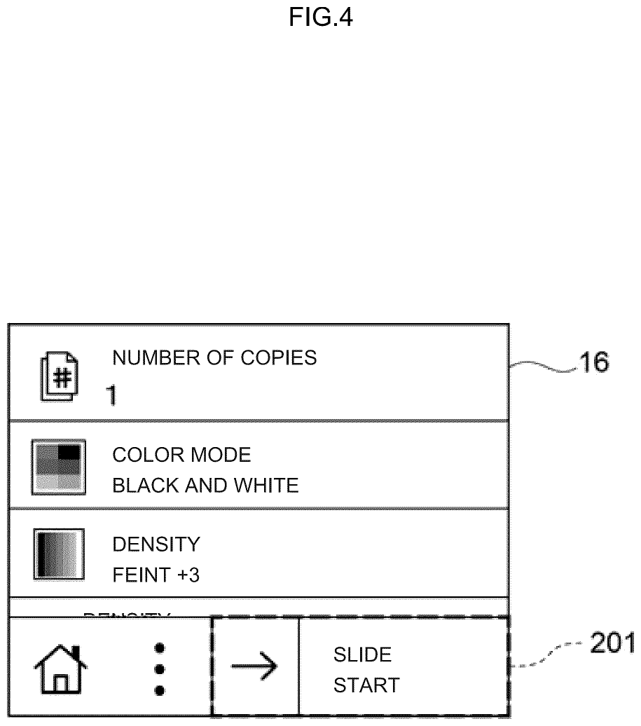

Description follows regarding an example of display of the user interface by the CPU 11. FIG. 4 is a diagram illustrating an example of a user interface displayed on the display section 16 by the CPU 11. FIG. 4 illustrates an example of the user interface displayed on the display section 16 in a state in which a user has not performed an operation on the display section 16 (a default state). In the default state of the present exemplary embodiment, the user interface is displayed on the display section 16 so as to enable a specific processing, such as print processing, facsimile transmission processing, or the like, to be executed by a user touching a finger on an instruction region 201 and sliding the finger toward the right.

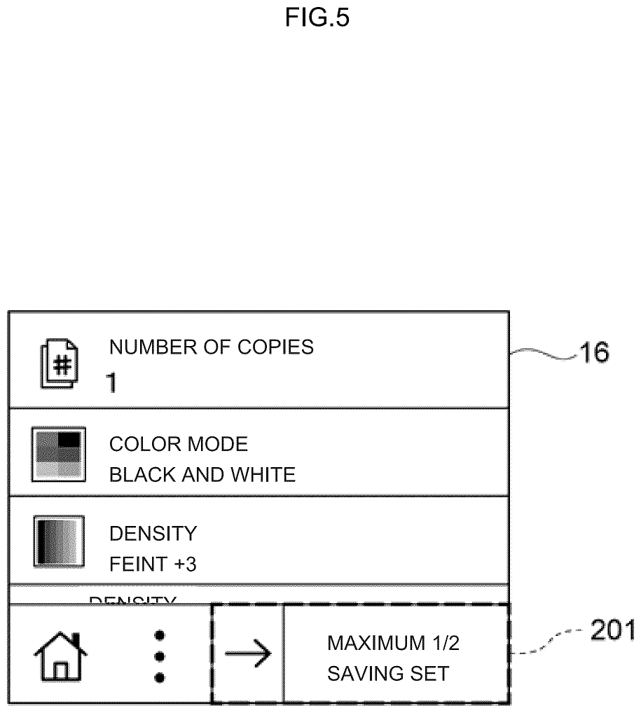

FIG. 5 is a diagram illustrating an example of a user interface displayed on the display section 16 by the CPU 11. FIG. 5 illustrates an example of a user interface displayed on the display section 16 in a state in which a user has touched a finger onto the instruction region 201. In FIG. 5, information of “maximum ½ saving setting” is displayed in the instruction region 201 as the priority information. This is because a setting has been adopted that enables a maximum ½ cost saving to be achieved compared to a default setting.

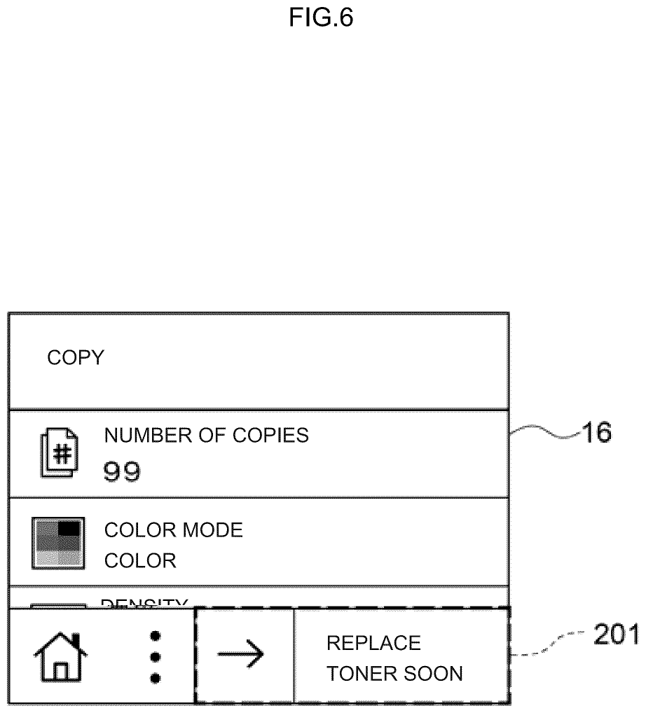

FIG. 6 is a diagram illustrating an example of a user interface displayed on the display section 16 by the CPU 11. FIG. 6 illustrates an example of a user interface displayed on the display section 16 in a state in which the user has touched a finger onto the instruction region 201. FIG. 6 illustrates information of “replace toner soon” displayed in the instruction region 201 as the priority information. This indicates a state needing toner replacement when the information display device 10 is an image forming device. In cases in which content needing attention such as toner replacement is being displayed, the CPU 11 may change a background color of the instruction region 201 from that when other information is being displayed. The CPU 11 may, for example, use green as the background color of the instruction region 201 in the default state when a user is not performing an operation on the display section 16, such as FIG. 4, and may change the background color of the instruction region 201 to yellow or red when displaying content needing attention.

When the finger of the user has been detected as moving away from the display section 16, the CPU 11 may return the information displayed at the instruction region 201 from the priority information to the information of the default state.

Explanation follows regarding an example of a method of deciding the priority information by the CPU 11. The CPU 11 may decide the priority information to prioritize for display on the display section 16 by cross-checking the collected information against content of a table in which information priorities have been established.

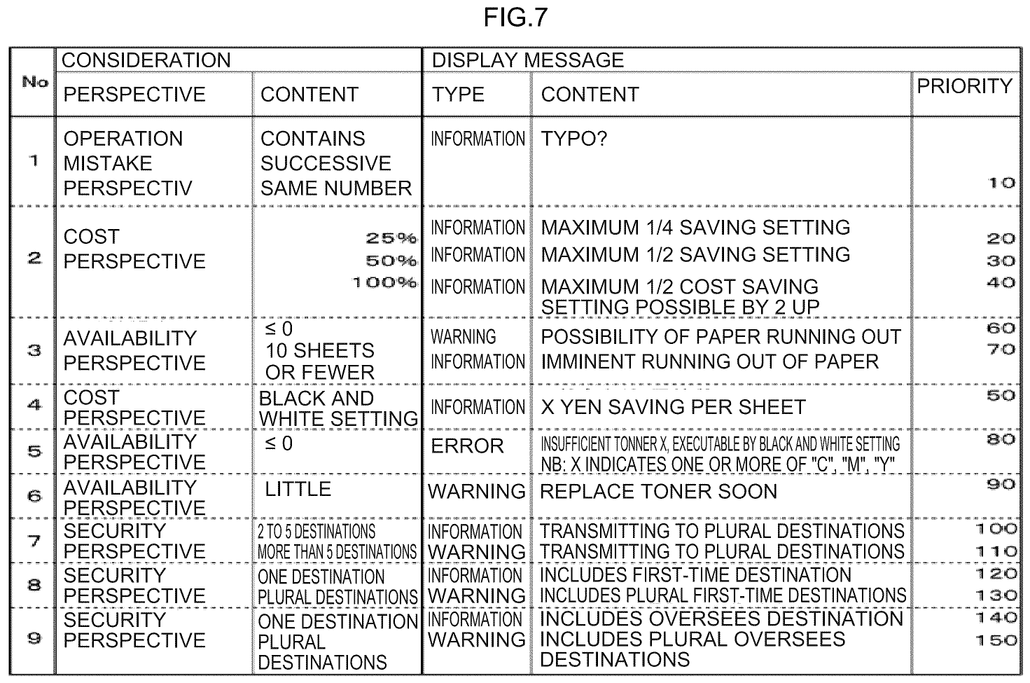

FIG. 7 is a diagram illustrating an example of a table the CPU 11 references when deciding the priority information. In the present exemplary embodiment, the CPU 11 references content pre-classified from perspectives of a perspective of operation mistake, a perspective of cost, a perspective of availability, and a perspective of security, and decides a display message based on defined priorities for the respective content. The display message is an example of the priority information.

The CPU 11 references a setting for the number of print copies, and is able to decide a display message appropriate for when there are successive instances of the same number because there is conceivably a typo when successive instances of the same number occur in a number input by the user.

Moreover, the CPU 11 is able to find a proportion of printed surface with respect to the paper from settings of a number of pages to be printed per single sheet and whether or not there is double-sided printing, and is able to decide the display message appropriate to the found proportion of printed surface.

The CPU 11 is also able to determine whether or not paper will run out during printing from the settings of the number of print copies, the number of pages to be printed per single sheet, and whether or not there is double-sided printing, and from the number of sheets of paper remaining, enabling a display message to be decided appropriate to the determination result.

The CPU 11 also references a setting of a printing color mode, and when black and white printing has been set is able to decide a display message related to cost that can be saved by setting black and white printing.

The CPU 11 is also able to determine whether or not there is insufficient toner from the settings of the number of print copies, the number of pages printed per single sheet, whether or not there is double-sided printing, the printing color mode, and from the current toner state, enabling a display message appropriate to insufficient toner to be decided when there is insufficient toner.

The CPU 11 is also able to determine whether or not now is time to replace toner from the current toner state, enabling a display message prompting toner replacement to be decided when determined that now is time to replace toner.

The CPU 11 is able to determine whether or not there are plural transmission destinations for transmission from a setting of facsimile transmission destinations, enabling a display message that there are plural transmission destinations for transmission to be decided when there are plural transmission destinations for transmission.

The CPU 11 is also able to determine whether or not there is transmission to a transmission destination not yet transmitted to from the facsimile transmission destination setting and a past facsimile transmission history, enabling a display message to be decided that there is one or plural first-time transmission destinations included when first-time transmission destination(s) is/are included for transmission.

The CPU 11 is also able to determine whether or not there is transmission to an overseas transmission destination from the facsimile transmission destination setting, enabling a display message that there is transmission to an overseas transmission destination to be decided when there is transmission to an overseas transmission destination.

Namely, the CPU 11 is able to decide the priority information based on one setting or information, or based on a combination of plural settings or information.

For example, in cases in which a succession of the same number is included in a number input by a user, and there is also nothing corresponding to the set content illustrated in FIG. 7, as the priority information the CPU 11 decides information to get the user to verify whether or not this number is a typo.

The CPU 11 may evaluate the priority from the perspective of cost by a relative value from the default setting. For example, in cases in which the default setting is neither setting to perform 2-up printing (2 pages printed per single sheet) nor setting of double-sided printing, when changed by a user so as to perform 2-up printing and double-sided printing a consideration result from a cost perspective is 25%. Only 1 page can be printed per single sheet in the default setting but 4 pages can be printed per single sheet after the setting change. However in cases in which the default setting was a setting to perform 2-up printing and not to perform double-sided printing, when changed by a user so as to perform 2-up printing and double-sided printing the consideration result from a cost perspective is 50%. Although in the default setting 2 pages can be printed per single sheet in the default setting, 4 pages can be printed per single sheet after the setting change.

In cases in which there is a need to display plural messages, the CPU 11 may display these in sequence from the highest priority, or may display all of these messages. In cases in which these are not able to fit inside the instruction region 201, the CPU 11 may switch display in priority sequence at each fixed interval. Moreover, in cases in which the setting or the state has a high relevance to a screen being displayed, then the CPU 11 may add points to or weight defined priorities.

In relation to a setting being displayed at the user interface of the display section 16 or a state pertaining thereto, the CPU 11 may acquire the priority information while taking into account a cross-check result against a table. More specifically, the CPU 11 may add points to or weight the defined priorities in the table in relation to a setting being displayed at the user interface of the display section 16 or a state pertaining thereto.

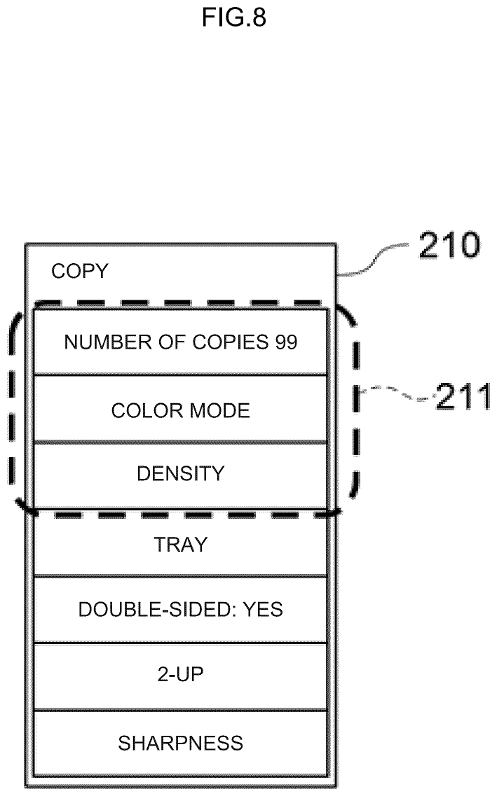

FIG. 8 is a diagram to explain adding points to or weighting defined priorities. Consider a case in which a copy setting 210 such as in FIG. 8 is set, and a range indicated by reference numeral 211 is being displayed on the display section 16. The CPU 11 may add points to or weight the defined priorities in relation to setting the number of copies, color mode, and density displayed on the display section 16. For example, in the table of priorities illustrated in FIG. 7 the priority for the number of copies of 99 copies from the operation mistake perspective is 10 points and the priority for double-sided setting from the cost perspective (50%) is 30 points. However the number of copies is being displayed on the display section 16 but the double-sided setting is not being displayed on the display section 16. The CPU 11 accordingly adds a specific number of points to the priority from the operation mistake perspective. For example, the priority from the operation mistake perspective becomes 60 points when the CPU 11 adds 50 points to the priority from the operation mistake perspective. This means that the CPU 11 acquires as the priority information a message from the operation mistake perspective, whose priority has exceeded that from the cost perspective, and displays the message from the operation mistake perspective on the display section 16.

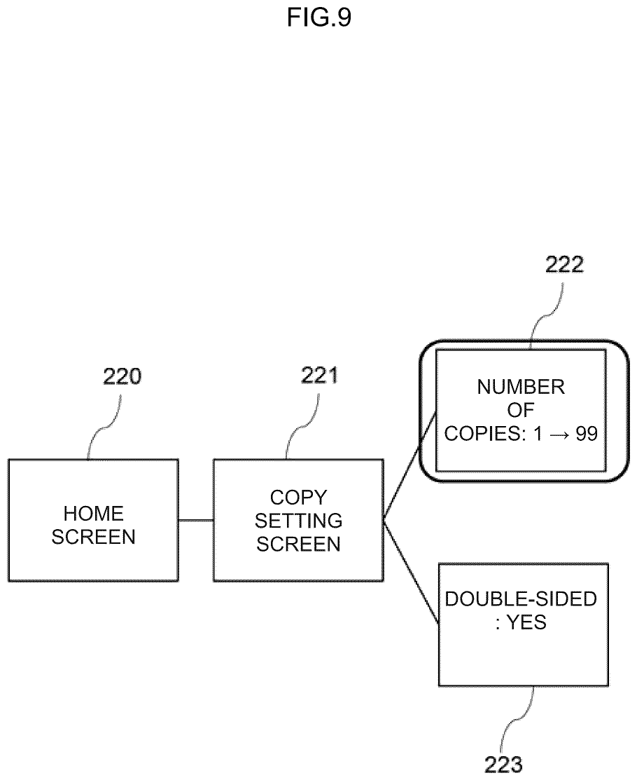

FIG. 9 is a diagram to explain adding points to or weighting defined priorities, and is a diagram to explain an example of a change of priority due to screen switching. Consider a case in which user operation has switched a home screen 220 to a copy setting screen 221, and then further switched to a number of copies setting screen 222, and the number of copies has been changed from 1 copy to 99 copies. In such cases the CPU 11 prioritizes the number of copies setting screen 222 being displayed on the display section 16 over the double-sided setting screen 223 not being displayed on the display section 16, and adds a specific number of points (for example 50 points) to the priority from the operation mistake perspective. Due to the priority from the operation mistake perspective now being 60 points, unless exceeded by another priority the CPU 11 acquires a message from the operation mistake perspective as the priority information, and displays the operation mistake perspective message on the display section 16.

The CPU 11 may add points to or perform weighting on the priorities for a setting not being displayed on the display section 16 according to a distance from a setting being displayed on the display section 16. For example, the CPU 11 may add points to or perform weighting on the priorities in accordance with a screen transition operation performed by a user. A scroll operation, a screen switching operation, or the like performed by a user are examples of such a screen transition operation performed by a user. For example, in the example of FIG. 8, from out of settings not being displayed on the display section 16 the CPU 11 may increase the added points to or weighting the most for the priority from the availability perspective for the number of sheets of paper remaining in a tray. Moreover for example, in cases in which the number of copies setting screen 222 is being displayed as in the example in FIG. 9, an added point amount or weighting may be increased the most for the setting displayed on the double-sided setting screen 223 furthest from the number of copies setting screen 222.

In the present exemplary embodiment, the priority information has been decided by reference to a prepared table, however for example, the CPU 11 may perform machine learning using setting content and processing results of a user so as to update the values of the proprieties set in the table. For example, in cases in which input of successive numbers is known to be performed frequently, the CPU 11 may lower the priority related to input of successive numbers.

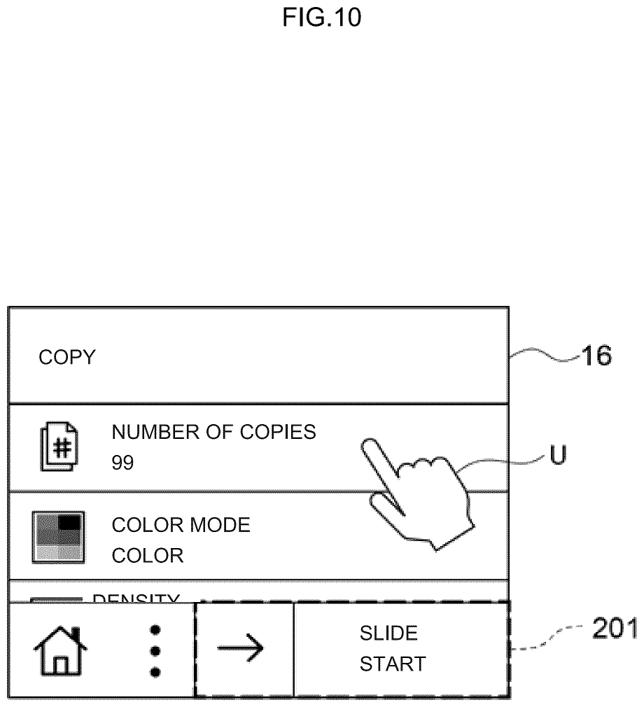

Description follows regarding modified examples of display of the user interface. FIG. 10 is a diagram illustrating an example of a display of a user interface by the CPU 11. FIG. 10 illustrates an example of a user interface displayed on the display section 16 in a state in which a finger U of a user is not touching the display section 16. In this state the CPU 11 displays a phrase “slide start” at the instruction region 201.

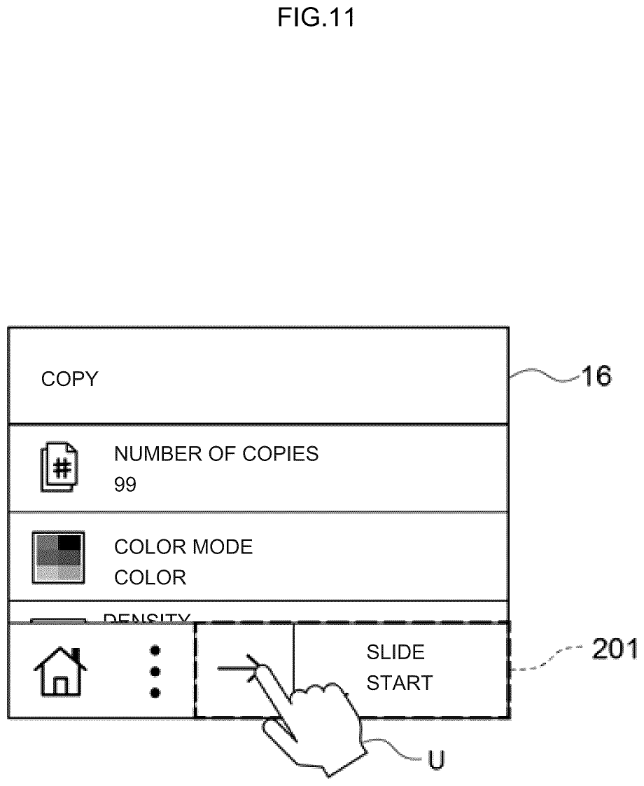

FIG. 11 is a diagram illustrating an example of a display of the user interface by the CPU 11. FIG. 11 illustrates an example of the user interface displayed on the display section 16 in a state in which the finger U of a user is touching the instruction region 201 of the display section 16. The CPU 11 displays the phrase “slide start” at the instruction region 201 in cases in which there is no priority information present in this state.

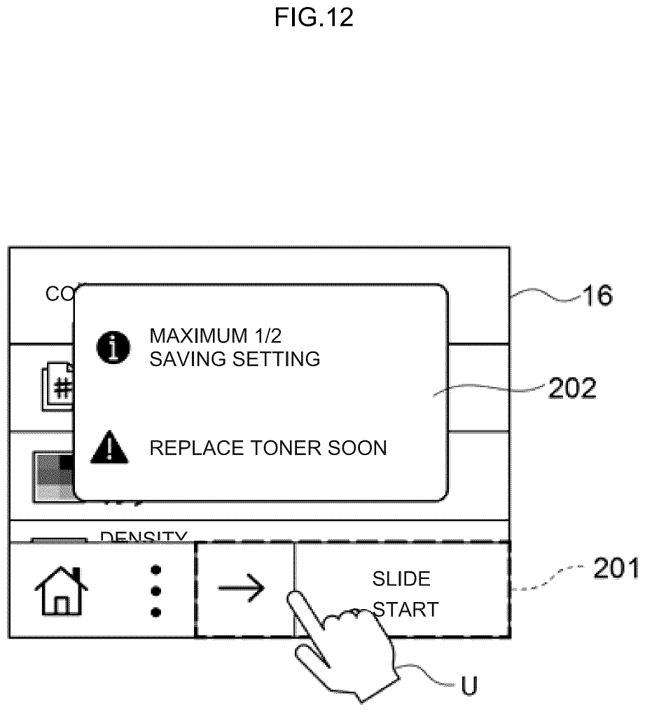

FIG. 12 is a diagram illustrating an example of the user interface displayed by the CPU 11. FIG. 12 illustrates an example of the user interface displayed on the display section 16 in a state in which the finger U of a user is touching the instruction region 201 of the display section 16. In cases in which there is priority information present in this state, the CPU 11 may perform pop up display of the priority information at an information display region 202, namely may display the priority information overlaid on the operation screen. Note that the CPU 11 may display the information display region 202 on the display section 16 when the finger U of the user has been detected to have touched the instruction region 201 of the display section 16 for a specific period of time or longer.

The CPU 11 may re-acquire the priority information and display the acquired priority information in the display section 16 in accordance with a change in setting by the user.

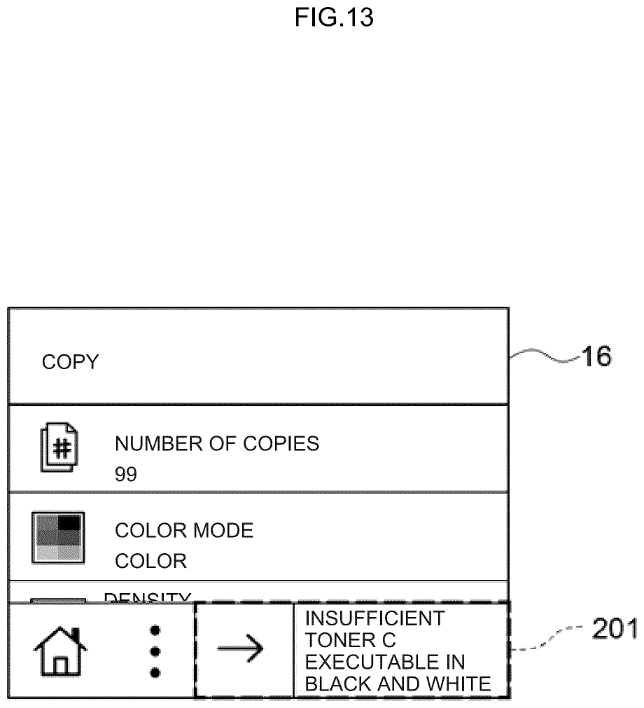

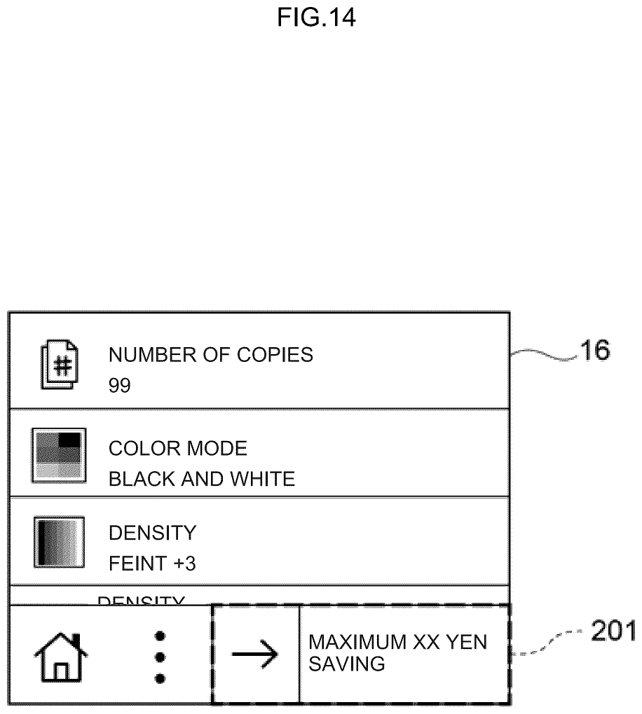

FIG. 13 is a diagram illustrating an example of a display of a user interface by the CPU 11. FIG. 13 illustrates an example in which cyan (C) toner is insufficient, and a message that print processing is executable in black and white is displayed on the instruction region 201 as the priority information. In this state, the CPU 11 re-acquires the priority information in accordance with a change in color mode when the user has changed the color mode from color to black and white, and displays the acquired priority information on the display section 16. FIG. 14 is a diagram illustrating an example of a display of a user interface by the CPU 11. FIG. 14 illustrates an example in which the priority information displayed at the instruction region 201 has been changed from the state of FIG. 13 due to changing the color mode. Namely, in FIG. 14, the priority information from the cost perspective is displayed at the instruction region 201 due to now being able to perform printing because the color mode was changed from color to black and white.

Note that although in the present exemplary embodiment the CPU 11 has displayed priority information at the instruction region 201 when there is priority information present in a state in which the user has touched a finger on the instruction region 201, the present invention is not limited to such an example. The CPU 11 may display priority information at the instruction region 201 when there is priority information present even though the user has not touched a finger on the instruction region 201.

In this manner, the information display device 10 according to the present exemplary embodiment is able to acquire priority information to prioritize for display according to a state of the information display device 10 or content of setting of processing to be executed by the information display device 10, and is able to display the acquired priority information on the display section 16.

Note that although in each of the above embodiments the information display processing is executed by software (a program) being read by the CPU, the processing may be executed by various processors other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, the information display processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, although in each of the above embodiments cases have been described in which the program of the information display processing is pre-stored (installed) in the ROM or storage, there is no limitation thereto. The program may be provided in a format recorded on a non-transitory recording medium such as a compact disk read only memory (CD-ROM), digital versatile disk read only memory (DVD-ROM), universal serial bus (USB) memory, or the like. Moreover, the program may be in a format downloadable from an external device over a network.

In each of the above exemplary embodiments processor indicates widely defined processors, and includes general processors (for example a central processing unit (CPU) or the like), specialized processors (for example a graphics processing unit (GPU), an application specific integrated circuit (ASIC), an field programmable gate array (FPGA), a programmable logic device, and the like).

Moreover, operation of the processor in each of the above exemplary embodiments is not limited to being performed on a single processor, and may be performed by plural processors present at physically separated locations acting in coordination with each other. Moreover, the sequence of each operation of the processors is not limited to only the sequences described in the above exemplary embodiments, and may be modified as appropriate.

### EXPLANATION OF REFERENCE NUMERALS

10 information display device
201 instruction region
202 information display region
210 copy setting

1. An information display device comprising a processor, wherein the processor performs processing including:
collecting device information;
acquiring priority information to prioritize for display based on the collected information; and
displaying the acquired priority information at a specific region at an operation screen displayed at a user interface.

2. The information display device of claim 1, wherein the processor displays, as the priority information, information related to an event that occurs due to processing executed based on an operation instruction from a user.

3. The information display device of claim 2, wherein the processor acquires the priority information in accordance with a change of setting for the processing.

4. The information display device of claim 1, wherein the processor displays information related to an event occurring at the device as the priority information.

5. The information display device of claim 4, wherein the processor acquires the priority information in accordance with a change in setting on the device.

6. The information display device of claim 1, wherein the processor acquires the priority information in accordance with a change of content being displayed at the operation screen.

7. The information display device of claim 6, wherein the processor acquires the priority information in accordance with a screen transition operation from a user on the user interface.

8. The information display device of claim 7, wherein the processor acquires the priority information in accordance with a scroll operation from the user on the user interface.

9. The information display device of claim 1, wherein the specific region is a region for receiving execution of processing from a user.

10. The information display device of claim 1, wherein the specific region is a region displayed overlaid on the operation screen.

11. The information display device of claim 1, wherein the processor acquires the priority information by cross-checking content of the collected information against a pre-established table.

12. The information display device of claim 11, wherein the processor acquires the priority information by taking into account a result of cross-checking information related to content being displayed at the operation screen.

13. A non-transitory computer-readable storage medium storing a computer program executable by a computer to perform processing, the processing including:
collecting device information;
acquiring priority information to prioritize for display based on the collected information; and
displaying the acquired priority information at a specific region at an operation screen displayed at a user interface.
